(19) United States
(12) Patent Application Publication
(10) Pub. No.: US 2022/0333404 A1
(43) Pub. Date: Oct. 20, 2022

(54) Removable Hands-Free Door Pull Openers

(71) Applicant: Government of the United States, as represented by the Secretary of the Air Force, Wright-Patterson AFB, OH (US)

(72) Inventors: John P. McIntire, Dayton, OH (US); Matthew Srnoyachki, Moraine, OH (US); Felicia N. Harlow, Beavercreek, OH (US)

(21) Appl. No.: 17/234,946

(22) Filed: Apr. 20, 2021

(51) Int. Cl. E05B 1/00

(52) U.S. Cl. CPC E05B 1/0053; E05B 1/0069; E05B 1/0015

(57) ABSTRACT

Removable hands-free door pull openers are disclosed that can be attached to doors without penetrating the surface of the door. The door pull opener includes a door clamping portion configured to clamp the free edge of a door that receives a lock, and a hook portion joined to the door clamping portion. The hook portion includes a bend portion and is configured for a person to insert their forearm between one side of the door and the bend portion so that they may pull open a door without touching the door or the door pull opener with their hand. A foot pull door opener is also provided. A door latch bolt cover that covers a door latch bolt is also disclosed.

### RIGHTS OF THE GOVERNMENT

The invention described herein may be manufactured and used by or for the Government of the United States for all governmental purposes without the payment of any royalty.

### FIELD OF THE INVENTION

The present invention relates generally to door openers and, more particularly, to removable hands-free door pull openers.

### BACKGROUND OF THE INVENTION

The spread of infectious disease can be partly mitigated by reducing the number of shared objects required for touching in community spaces, including door handles, knobs, and lever sets.

There are devices currently marketed that permit arm-pull or foot-pull action to open the door, without requiring hand-touching of the knob or lever. These devices may be intended to minimize hand-touching of community shared door knobs and levers to prevent the spread of contagious disease. However, many of these devices require permanent attachment to the doors and can damage the look and integrity of the door surface, potentially altering fire safety ratings, as well as requiring more difficult installation and later removal of the devices.

A need exists for improved hands-free door pull openers, particularly those that can be non-permanently attached to doors, and be easily installed and removed leaving the doors damage-free.

### SUMMARY OF THE INVENTION

The present invention relates generally to door openers and, more particularly, to removable hands-free door pull openers. Door latch bolt covers are also provided that allow doors to be opened without turning a knob or handle to disengage a latch if present, permitting the arm or foot-pull openers to be used on doors that would otherwise still require hand-touching to open the door. On many community/public doors such as external doors of a business, latches are completely disengaged during open business hours; or for community/public restrooms, there is often no latching mechanism. In these cases, the arm or foot pulls can be used completely hands-free; without the need for an additional “latch blocking” mechanism.

While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention, a removable hands-free door pull opener is provided for joining to a door. The door has a front surface, a back surface, and a free edge that receives a lock, and at least a portion of the front and back surfaces are generally planar. The door pull opener comprises:

a door clamping portion configured to clamp to a portion of the front and back surfaces of a door around the free edge of the door; and

a hook portion joined to the door clamping portion, wherein the hook portion comprises: an extension portion that is configured to extend away from the plane of the door; and a bend portion that extends in a direction that forms an angle with the extension portion, wherein the extension portion has a length that spaces the bend portion away from the plane of the door a sufficient distance for a person to insert their forearm between one surface of the door and the bend portion.

A method of attaching a hands-free door pull opener (such as that described above) to a door is also provided. The method may comprise placing the door clamping portion of the door pull opener around the free edge of a door on the side of the door so that the door clamping portion clamps to a portion of the front and back surfaces of the door. The door clamping portion exerts inwardly oriented forces against the front and back surfaces of the door that are sufficient to hold the centerline of the door clamping portion in a generally horizontal orientation on the door. In some embodiments, the door clamping portion may be adjustable, and the method may include a step of adjusting the door clamping portion. The extension portion of the door pull opener extends away from the plane of the door a sufficient distance for a person to insert their forearm between one surface of the door and the bend portion.

A foot pull door opener for joining to a bottom portion of a door is also provided. The foot pull door opener can either be joined to the bottom edge of the door, or the side edge of the door adjacent the bottom of the door. In some embodiments, the foot pull door opener comprises: a generally L-shaped base component comprising a base leg for placing adjacent to a bottom or side edge of a door and a first upright leg; a grip plate; and a clamping mechanism for adjusting the movement of the grip plate relative to the first upright leg and toward or away from the plane of a door.

The door pull opener and the foot pull door opener are constructed with the strength to attach firmly, retain their position with pulling arm (or foot) force, and may be ergonomically designed to be appropriate for arm or foot placement.

A door latch bolt cover is also provided. The door latch bolt cover comprises a door clamping portion configured in the form of a spring to clamp the free edge of a door that receives a lock and cover the door latch bolt.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a perspective view of one embodiment of a hands-free door pull opener and door latch bolt cover installed on a door shown with the door closed.

FIG. 2 is a perspective view of the hands-free door pull opener and door latch bolt cover installed on a door shown with the door opened.

FIG. 3 is a perspective view of the side of the door opposite the side with the hands-free door pull opener showing a sign on the same.

FIG. 4 is a perspective view of a modified version of the hands-free door pull opener shown in FIGS. 1 and 2.

FIG. 5 is a top view of the modified version of the hands-free door pull opener shown in FIG. 4.

FIG. 6 is a perspective view of another embodiment of a hands-free door pull opener installed on a door shown with the door partially open.

FIG. 7 is a side perspective view of the hands-free door pull opener shown in FIG. 6 installed on a door.

FIG. 8 is a perspective view of the hands-free door pull opener shown in FIG. 6.

FIG. 9 is a perspective view of one embodiment of a door latch bolt cover.

FIG. 10 is a plan view of the door latch bolt cover shown in FIG. 9.

FIG. 11 is a side view of one embodiment of a foot pull door opener.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The present invention relates generally to door openers and, more particularly, to removable hands-free door pull openers. Door latch bolt covers are also provided that functionally disengage door latches, thus allowing doors to be opened hands-free in conjunction with a door pull device and without requiring the additional actions of turning a knob or handle.

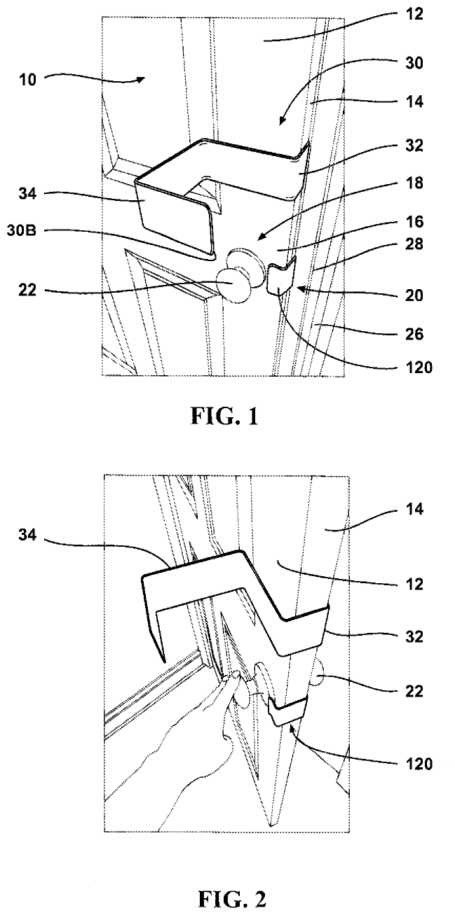

FIG. 1 shows one non-limiting embodiment of a removable hands-free door pull opener (or simply “door pull opener”) 30 and a door latch bolt cover (or simply “door latch cover”) 120 joined to a door 10. The parts of the door 10 shown include: a lock stile 12 (that contains a lock), a free edge 14 of the lock stile, a lock rail 16, a lockset 18, a latch 20 (which is covered by the door latch cover in FIG. 1), a knob 22, and a frame 26. The door latch 20 engages a strike plate 28 on a portion of the door frame 26 facing the free edge 14 of the door 10.

The door pull opener 30 comprises a door clamping portion (or “door attach clasp”) 32 configured to clamp to opposing sides of the lock stile 12 around the free edge 14 of the door, and a hook portion 34 that is joined to the door clamping portion 32. The door clamping portion 32 and the hook portion 34 can be integral parts of a single component, or they may comprise separate components that are joined together. In the embodiment shown in FIG. 1, door pull opener 30 comprise a single component (or member) having a first end 30A (FIG. 4) and a second end 30B, where one portion of the member comprises the door clamping portion 32 and another portion comprises the hook portion 34.

The door clamping portion 32 can comprise any suitable structure that is capable of removably joining the door pull opener 30 to a door 10 as described above. The terms “removable” and “removably”, as used herein, mean that the door clamping portion 32 can be joined to the door without fasteners that penetrate the surface of the door and without marking, marring, or damaging the surface of the door. In the embodiment shown in FIG. 1, the door pull opener 30 can be joined to the door (and removed from the door) without the assistance of tools.

As shown in FIGS. 1 and 2, the body of the door pull opener 30 extends primarily horizontally when joined to the door 10. The door clamping portion 32 is configured to hold the door pull opener 30 in this orientation by a clamping force that is oriented directionally inward from the opposing sides of the lock stile 12. The door clamping portion 32 should be free of any screws or other fasteners that penetrate into the surface of the door to hold the door clamping portion 32 onto the door 10.

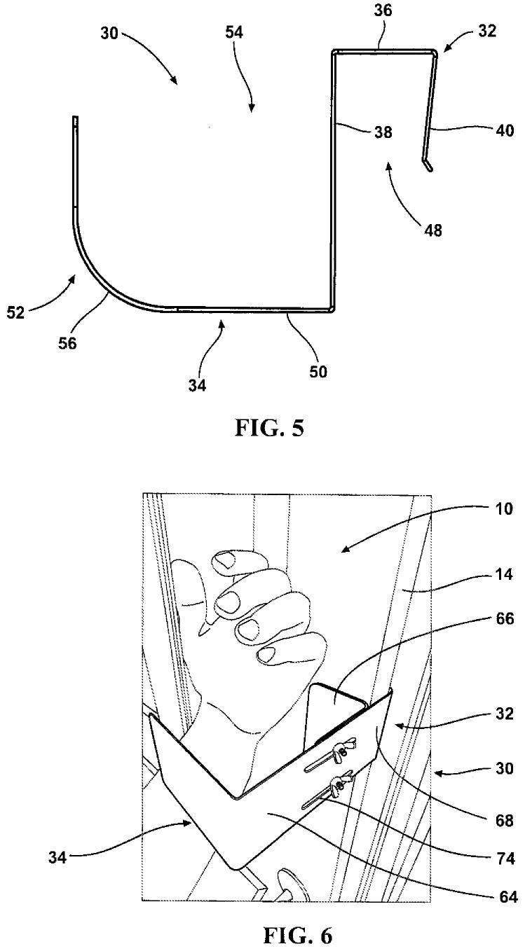

In the embodiment shown in FIGS. 1 and 2, the clamping force is provided by bending or otherwise forming the door clamping portion 32 of the member into a resilient spring configuration (as shown on the alternative embodiment in FIGS. 4 and 5). These embodiments of the door clamping portion 32 have a generally U-shaped configuration. The U-shaped door clamping portion 32 comprises a base (or “side portion”) 36 and two leg portions 38 and 40. The side portion 36 is sized slightly larger than the width of the edge 14 of the door 10. In some cases, the side portion 36 may be about two inches in length (measured between the leg portions 38 and 40). The leg portions 38 and 40 may extend at an angle from the side portion 36 that is less than or equal to about 90° (so long as at least one angle is less than 90°). The leg portions 38 and 40 do not have to extend from the side portion at the same angle. For example, as shown in FIGS. 4 and 5, the inner leg portion 38 may extend from the side portion 36 at an angle of about 90°, and the outer leg portion 40 may extend from the side portion at an angle of less than 90°. In the embodiment shown in FIG. 5, the outer leg portion 40 extends from the side portion at an angle of about 84°.

As shown in FIGS. 4 and 5, the outer leg portion 40 has a proximal end 42 where it extends from the side portion 36 and a distal end 44. The outer leg portion 40 may have an outward bend 46 adjacent the distal end 44 of the same to reduce or eliminate the possibility for the door clamping portion 32 to mar the surface of the door 10. The outer leg portion 40 may have any suitable length. In one embodiment, the outer leg portion 40 may have a length of about 2 inches from its proximal end to the outward bend.

FIG. 5 shows that the door clamping portion has a mouth 48 opposite the side portion 36 that is defined by the leg portions 38 and 40. The mouth 48 can have any suitable width. The width of the mouth 48 is typically less than the width of the side portion 36. In one embodiment, the width of the mouth 48 is about 1.65 inches.

The hook portion 34 allows the door pull opener 30 to be pulled by a person's arms or feet, thus swinging a door open towards the user (in-swing). The hook portion 34 may have any suitable configuration that permits a person to insert their forearm between one side of the door and the hook portion 34 so that they can open the door with their forearm without touching the door 10 or the door pull opener 30 with their hands. The hook portion 34 may comprises a spacing/extension portion (or simply the “extension portion”) 50 and a bend portion 52.

The extension portion 50 is configured to extend outwardly away from the plane of the door 10. The extension portion 50 in these embodiments is joined to the inner leg portion 38 of the door clamping portion 32, and forms an angle, such as an angle of about 90° therewith. The extension portion 50 has a length that is sufficient to space the bend portion 52 away from the plane of the door 10 a distance sufficient for a person to insert their forearm between one side of the door and the bend portion 52. In some embodiments, the length of the extension portion 50 may be about 5 inches.

The bend portion 52 forms an angle with the extension portion 50. The angle formed therebetween is such that the bend portion 52 doubles back and extends in a direction generally parallel to the inner leg portion 38, but in the opposite direction as the distal end 44 of the outer leg portion 40. The extension portion 50 and the bend portion 52 may be considered to form a second generally U-shaped configuration in combination with the inner leg portion 38. The U-shaped structure formed in combination with the inner leg portion 38 forms a second mouth 54 (for a person's forearm) that opens in the opposite direction as the mouth 48 of the door clamping portion 32. This second mouth 54 may be any width suitable for allowing a person's forearm to fit therein. In some cases, the width of the second mouth 54 may range from greater than 3 inches to about 9 inches. In one embodiment, the width of the second mouth 54 may be about 5 inches.

The angle between the extension portion 50 and the bend portion 52 can be any suitable angle that permits a person to pull the door open with their forearm. In some cases, the hook portion 34 may have a generally L-shaped top view configuration. As shown in FIGS. 1 and 2, the extension portion 50 and the bend portion 52 may be rectilinear, and the angle between the bend portion 52 and the extension portion 50 may be about 90°. As shown in FIGS. 4 and 5, the door pull opener 30 may have an ergonomic hook design in which at least a portion 56 of the hook portion 34 has a curvilinear configuration. In some cases, the bend portion 52 may have a length of about 3.75 inches.

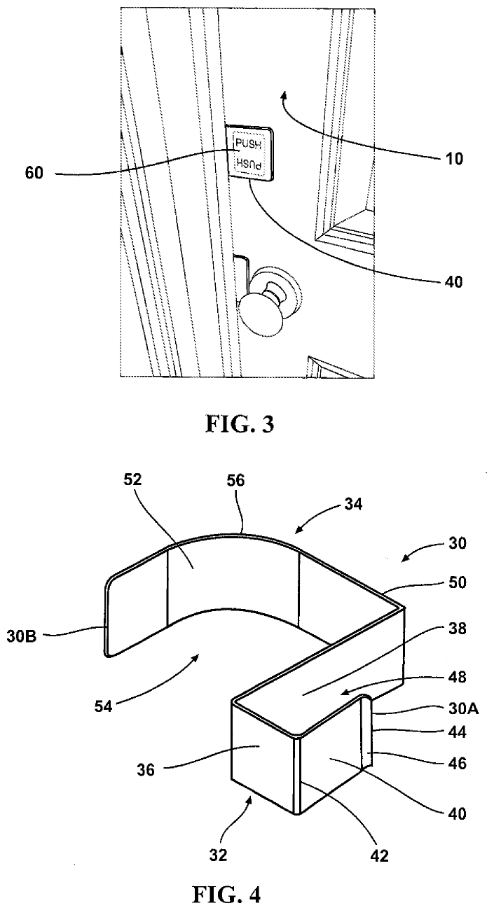

FIG. 3 shows that the door pull opener 30 may further comprise optional indicator signs 60 on the face and back of the door pull opener 30 that notifies a user to either “pull” or “push” depending on which side of the door a user is on. In the embodiment shown in FIG. 3, the indicator sign is placed on the outer leg 40 of the door pull opener 30.

The door pull opener 30 may be made from any suitable material or materials. The door pull opener 30 may be made out of a material that is thin enough so that when the device is placed on the door 10, the door can still shut and the latch functionality is retained if so desired (by fitting in the gap between the door, frame, and door jamb). Any appropriately resilient and/or strong material can be utilized for this purpose. In some cases, the door pull opener 30 may be made out of a thin piece of steel.

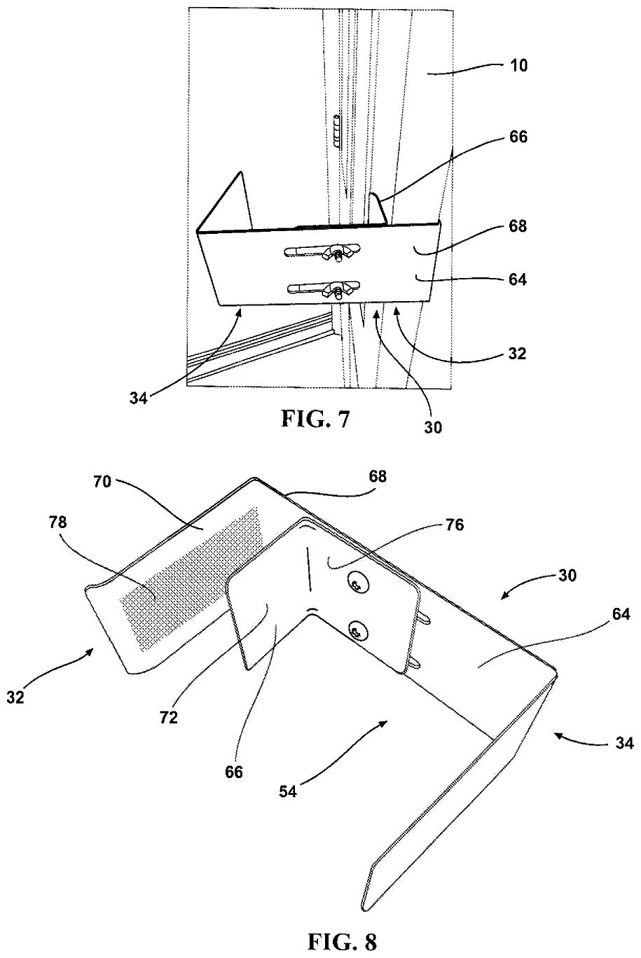

FIGS. 6-8 show an alternative embodiment of an adjustable door pull opener 30 which may include an adjustable clamping mechanism. The clamping mechanism can be used to accommodate variations in door thickness sizes, ranging from roughly 1.25″ to 2.5″, and/or to permit enhanced clamping forces for heavier or “tougher-to-grab” doors.

The door pull opener 30 with the adjustable clamping mechanism can be provided in several different configurations. In the embodiment shown in FIGS. 6-8, the adjustable door pull opener 30 comprises two components, a first component 64 and a second component 66. The first component 64 in the embodiment shown can be thought of as having a generally U-shaped configuration with an elongated base. The elongated base may be longer than the legs of the U-shape. The first component 64 comprises a part of the door clamping portion 32 that comprises a door edge covering portion 68 and a first partial clamp portion 70 (FIG. 8) that is configured for placing on a first side of a door opposite the hook portion 34, wherein a portion of the first component 64 also comprises the hook portion 34 of the door pull opener.

The second component 66 comprises an L-shaped component that is movably (e.g., slidably) joinable to the first component 64. The second component 66 comprises a second partial clamp portion 72 that is configured for placing on a second side of the door 10 which is the same side that the hook portion 34 extends outward from. The second partial clamp portion 72 combines with the first partial clamp portion 70 to form the door clamping portion 32. The second component 66 is movably joined to the first component 64 in this embodiment by providing the first component 64 with a pair of parallel horizontally-oriented slots 74, and the adjustable portion 76 of the second component 66 that forms the other part of the L-shape and which in contact with the first component 64 with a pair of holes therein for screws with wing nuts thereon. This provides adjustability in direction of toward and away from the plane of the door (that is, normal to the plane of the door).

In addition to its adjustability, the adjustable door pull opener 30 shown in FIGS. 6-8 differs from the door pull openers shown in the preceding figures in several respects. The extension portion 50 may extend outwardly in a direction that lies in the same plane as the edge 14 of the door 10. The mouth 54 of the hook portion 34 of the adjustable door pull opener 30 shown in FIGS. 6-8 opens in a direction opposite the free edge 14 of the door 10, while the mouth 48 of the hook portion 34 of the door pull openers 30 shown in the preceding figures open toward the free edge 14 of the door 10.

As shown in FIG. 8, door clamping portion 32 may also include non-stick grip or adhesive surface strips 78 in the inside surfaces of the inner and outer leg portions to retard against slippage of the device out of position and prevent scraping damage of the door during the installation or removal process. The non-stick grip or adhesive surface strips 78 can be applied to any of the embodiments described herein, and can be applied to any portion of the devices that directly contact any part of the door.

FIG. 11 shows one non-limiting embodiment of a removable hands-free foot pull door opener (or simply “foot pull door opener”) 80. In FIG. 11, the foot pull door opener 80 is joined to the bottom rail 24 of the door around the bottom edge of the door 10. In other embodiments, the foot pull door opener 80 can be joined to opposing sides of the lock stile 12 around the free edge 14 of the door near the bottom of the door 10. The foot pull door opener 80 may also be adjustable to fit different thickness doors.

The foot pull door opener 80 shown in FIG. 11 comprises two main components, a base component 84 and a grip plate 86. The base component 84 comprises a generally L-shaped component comprising a base leg 88 and a first upright leg 90 at a first end of the base leg 88. The first upright leg 90 makes an angle of about 90° with the base leg 88. The base component 84 further comprises a second upright leg 92 that is located between the first and second ends of the base leg 88. The second upright leg 92 also makes an angle of about 90° with the base leg 88. The base component 84 further comprises a hook portion 94 that includes a clip portion 96 (that may be inwardly-oriented) at the second end of the base leg 88. The clip portion 96 may have a serrated edge 98 for engaging the bottom of the shoe of a person opening the door 10. The base component 84 comprises a part of the door clamping portion 100 of the foot pull door opener 80. The first upright leg 90 is placed one side of the door 10 opposite the hook portion 94, and the second upright leg 92 is positioned adjacent to the same side of the door as the hook portion 94. The first and second upright legs 90 and 92, along with a portion of the base leg 88 therebetween comprise a door edge covering portion and part of a door clamping portion 100.

The grip plate 86 may comprise a generally planar component at least a portion of which is movable relative to the second upright leg 92. All or a portion of the grip plate 86 is movable toward and away from the plane of the door 10. The lower edge of the grip plate 86 may be in contact with the base leg 88, joined to the base leg, or it may be raised above the base leg 88. If the lower edge of the grip plate 86 is joined to the base leg 88, then the upper portion of the grip plate 86 should be movable toward and away from the plane of the door 10. The grip plate 86 is movable relative to the second upright leg 92 in this embodiment by utilizing a clamping mechanism. Any suitable type or number of clamping mechanisms can be used, including, but not limited to: clamping knobs (twist or screw clamps), ratcheting mechanisms, spring mechanisms, and cam-style friction clamps.

In the embodiment shown in FIG. 11, a plurality of clamping knobs (twist or screw clamps) 102 are used. The clamping knobs 102 comprise a threaded bolt portion (or bolt) 104 and a knob 106. The threaded bolt portion 104 extends through a hole in the second upright leg 92 to its distal end 108. When the knob is tightened, the distal end 108 of the bolt holds the grip plate 86 against the surface of the door 10. This provides adjustability in direction of toward and away from the plane of the door (that is, normal to the plane of the door).

The components of the foot pull door opener 80 shown in FIG. 11 can be made in any suitable manner. The base component 84 and a grip plate 86 can be made of any of the materials specified above for the door pull openers. The base component 84 can be bent to form the first upright leg 90 and the clip portion 96. The base component 84 can be provided with the second upright leg 92 by joining (e.g., welding) the same to the base component 84. Alternatively, the base component 84 can be formed by joining the hook portion 94 to a generally U-shaped element that comprises a portion of the base leg 88 and the first and second upright legs 90 and 92. An optional gusset plate or bar 110 can be joined to the base leg 88 and the second upright leg 92 to stabilize the same against flexing.

The door latch bolt cover 120 comprises a door clamping element configured to clamp the lock stile 12 of a door (free edge of a door that receives a lock) and cover a door latch bolt. The door latch bolt cover 120 effectively disables a door's latching system, so that the door handle does not have to be utilized (virtually any door can thus be turned into a hands-free arm-pull door). The term “door handle”, as used herein, includes any type of handle, knob, or lever used to retract a door latch bolt.

The door latch bolt cover 120 may comprise any suitable structure that fits over the door latch bolt and maintains the door latch bolt in a retracted position while allowing the door 10 to close. In some cases, as shown in FIG. 1, it may be desirable for the door latch bolt cover 120 to terminate short of the door handle, door knob 22, and escutcheon plate when it is installed on a door 10. The door latch bolt cover 120 can be constructed similarly to the door clamping portion 32 of the door pull opener 30.

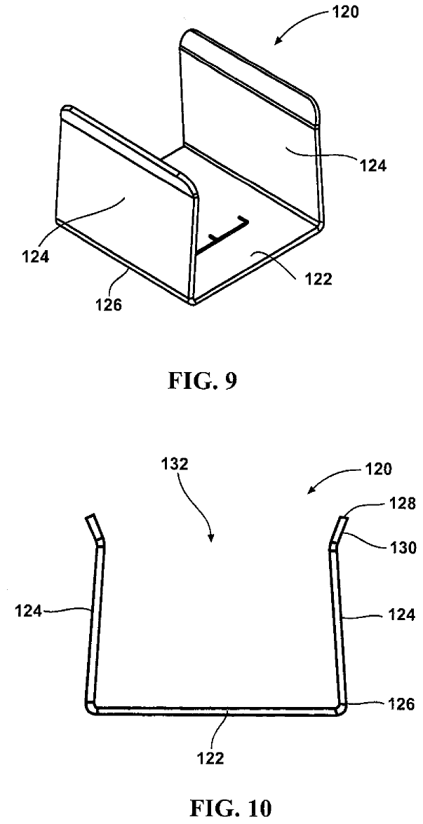

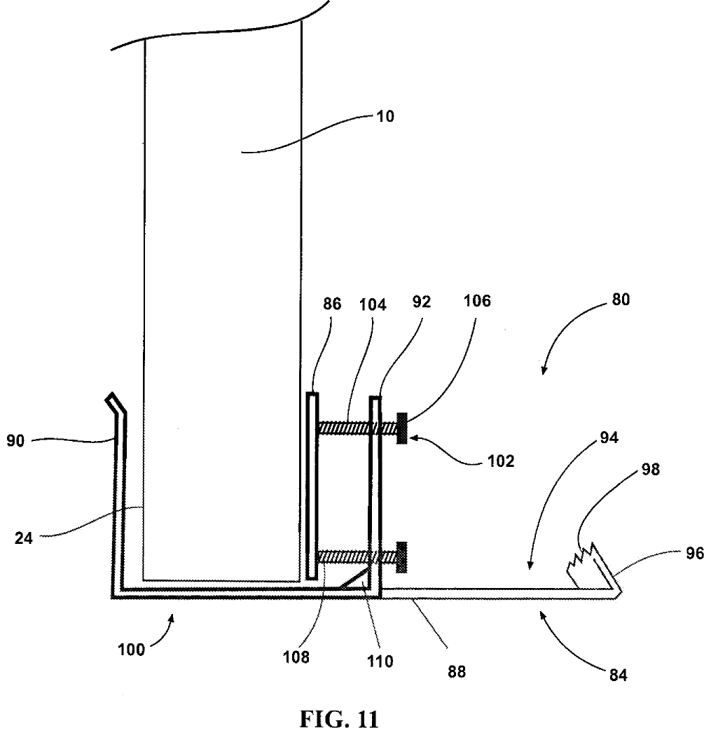

The door latch bolt cover 120 shown in FIGS. 9 and 10 comprises a single member that is bent into a resilient spring configuration. This embodiment of the door latch bolt cover 120 has a generally U-shaped configuration. The U-shaped door latch bolt cover 120 comprises a base (or “side portion”) 122 and two leg portions 124. The side portion 122 is sized slightly larger than the width of the edge of the door 10. In some cases, the side portion 122 may be about two inches in length. The leg portions 124 may extend at an angle from the side portion 122 that is less than or equal to about 90°. In the embodiment shown, the leg portions 124 extend from the side portion 122 at the same angle, which is about 86°. The leg portions 124, however, do not have to extend from the side portion 122 at the same angle. As shown in FIGS. 9 and 10, each leg portions 124 has a proximal end 126 where it extends from the side portion 122 and a distal end 128. Both leg portions 124 may have an outwardly bent portion 130 adjacent the distal end 128 of the same to reduce or eliminate the possibility for the door latch bolt cover 120 to mar the surface of the door 10. The leg portions 124 may have any suitable length. In one embodiment, the leg portions 124 may have a length of about 1.25 inches from their proximal end 126 to the outward bend and about 1.5 inches to their distal ends 128. FIG. 10 shows that the door latch bolt cover 120 has a mouth 132 that is opposite the side portion 122, and is defined by the leg portions 124. The mouth 132 can have any suitable width. The width of the mouth 132 of the door latch bolt cover 120 is typically less than the width of the side portion 122. In one embodiment, the width of the mouth 132 is about 1.7 inches.

The present invention may also be provided in the form of a kit of system comprising a door pull opener 30 and/or a foot pull door opener 80, and a door latch bolt cover 120.

The door pull opener 30, such as the embodiments shown in FIGS. 1-5, can be installed by simply sliding the door clamping portion 32 of the same onto the lock stile 12 so that it clamps onto opposing sides of the lock stile 12. The door latch bolt cover 120 is installed by sliding the same onto the lock stile 12 so that it covers the door latch bolt and clamps onto opposing sides of the lock stile 12.

There are numerous, non-limiting embodiments of the invention. All embodiments, even if they are only described as being “embodiments” of the invention, are intended to be non-limiting (that is, there may be other embodiments in addition to these), unless they are expressly described as limiting the scope of the invention. Any of the embodiments described herein can also be combined with any other embodiments in any manner to form still other embodiments.

For example, in one alternative embodiment, the adjustable door pull opener shown in FIGS. 6-8 may have an alternative adjustable clamping mechanism that is the same as, or similar to, the clamping mechanism for the foot pull opener shown in FIG. 11.

The door pull openers described herein can provide a number of advantages. It should be understood, however, that these advantages need not be required unless they are set forth in the appended claims. The door pull openers are important for minimizing the spread of germs by hand contact to shared surfaces, so would be beneficial for entry doors, educational facilities, even for handicapped persons (who might lack ability to grasp door knobs or levers). The door pull openers are unique in that the device installation is easy, non-permanent, and damage-free. The door pull openers are capable of being joined to either wood doors or metal doors.

The term “joined”, as used herein, encompasses configurations in which an element is directly secured to another element by affixing the element directly to the other element; configurations in which the element is indirectly secured to the other element by affixing the element to intermediate member(s) which in turn are affixed to the other element; and configurations in which one element is integral with another element, i.e., one element is essentially part of the other element. The term “joined” includes both those configurations in which an element is temporarily joined to another element, or in which an element is permanently joined to another element.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1-8 (canceled)

9. A hands-free door pull opener for joining to a door having a front surface, a back surface, and a free edge that receives a lock, wherein at least a portion of the front and back surfaces are generally planar, said door pull opener comprising:
a door clamping portion configured to clamp to a portion of the front and back surfaces of a door around the free edge of the door; and
a hook portion joined to said door clamping portion, wherein said hook portion comprises:
an extension portion that is configured to extend away from the plane of the door; and
a bend portion that extends in a direction that forms an angle with said extension portion, wherein the extension portion has a length that spaces said bend portion away from the plane of the door a sufficient distance for a person to insert their forearm between one surface of the door and the bend portion, said door pull opener comprising two components comprising:
a. a first component having a generally U-shaped configuration with an elongated base comprising a part of said door clamping portion that comprises a door edge covering portion and a first partial clamp portion that is configured for placing on a first side of a door opposite said hook portion, wherein said first component also comprises the hook portion of the door pull opener; and
b. a second component comprising an L-shaped component comprising two generally planar portions that form a right angle therebetween, wherein a first portion of the L-shaped component is slidably joined to the elongated base of the first component so that the second component may be moved along the base of the U-shaped first component, wherein a second portion of said second L-shaped component comprises a second partial clamp portion that is configured for placing on a second side of the door which is the same side that the hook portion extends outward from, wherein said second partial clamp portion may be combined with the first partial clamp portion to form said door clamping portion.

10. (canceled)

11. (canceled)

12. A door latch bolt cover for covering the door latch bolt of a door having a door handle for opening said door latch bolt, said door latch both cover comprising a door clamping portion configured in the form of a spring to clamp around the lock stile of a door and cover a door latch bolt.

13. The door latch bolt cover of claim 12 having a generally U-shaped configuration.

14. The door latch bolt cover of claim 12 having a door edge covering portion and legs wherein said door edge covering portion is sized to cover a door latch bolt, and said legs have a length that is less than the distance from the edge of the door to the door handle/escutcheon plate.

15. The door latch bolt cover of claim 12 which is configured to be joined to a door solely by clamping around the free edge of the door, and said door latch bolt cover is free of fasteners that penetrate the surface of the door, elements that magnetically adhere to the door, and elements that are joined to the door handle.

16. The adjustable hands-free door pull opener of claim 9 wherein the door edge covering portion and the first partial clamp portion form a right angle therebetween.

17. The adjustable hands-free door pull opener of claim 9 wherein the second component is movable along the base of the U-shaped first component in a direction perpendicular to the plane of the door.

18. The adjustable hands-free door pull opener of claim 9 wherein the base of the U-shaped first component has a pair of parallel horizontally-oriented slots formed therein, and the L-shaped second component is slidably joinable to the first component by bolts that pass through holes in the first portion of said L-shaped second component and the slots in the first component and said bolts are held in place using wing nuts.

19. The method of claim 10 wherein the door has a lock stile and the door handle operates a door latch bolt, and said method further comprises a step of placing a door latch bolt cover for covering the door latch bolt of the door wherein the door latch both cover comprises a door clamping portion configured in the form of a spring to clamp around the lock stile of a door and cover the door latch bolt.
